(19) United States
(12) Patent Application Publication
(10) Pub. No.: US 2023/0325206 A1
(43) Pub. Date: Oct. 12, 2023

(54) Computer-Implemented Method and System for the Dynamically Executing an Application Program by a Platform

(71) Applicant: Siemens Aktiengesellschaft, Muenchen (DE)

(72) Inventors: Sebastian GEIGER, Wien (AT); Vladimir ZAHORCAK, Borinka (SK); Herbert TAUCHER, Wien (AT); Christian CECH, Ebreichsdorf (AT)

(21) Appl. No.: 18/022,916

(22) PCT Filed: Aug. 11, 2021
(86) PCT No.: PCT/EP2021/072417

§ 371 Date: Feb. 23, 2023

(30) Foreign Application Priority Data
Aug. 26, 2020 (EP) 20192909.8

(51) Int. Cl. G06F 9/445

(52) U.S. Cl. CPC G06F 9/44521

(57) ABSTRACT

A computer-implemented method for dynamically executing an application program by a platform including a processor with a program memory and a programmable logic unit, wherein a first application program having a first module is loaded from an application database into the program memory and/or the programmable logic unit during a programming mode and executed as first program code during an execution mode, where a processor or the programmable logic unit performs a check during the execution mode based on a predefined criterion to determine whether a second application program having a second module should be loaded from the application database and, if so, the system switches to the programming mode and the second module is loaded into the program memory and/or the programmable logic unit and executed as second program code, where the system switches to the execution mode in which the second program code is executed.

### CROSS-REFERENCE TO RELATED APPLICATIONS

This is a U.S. national stage of application No. PCT/EP2021/072417 filed 11 Aug. 2021. Priority is claimed on European Application No. 20192909.8 filed 26 Aug. 2020, the content of which is incorporated herein by reference in its entirety.

### BACKGROUND OF THE INVENTION

### 1. Field of the Invention

The invention relates to a computer-implemented method and to a system for dynamically executing at least one application program by a platform that includes a processor comprising a program memory and that includes a programmable logic unit, where the processor and the programmable logic unit support a programming mode and an execution mode, at least one first application program comprising at least one first module is loaded into in the program memory and/or into the programmable logic unit during the programming mode so as to be executable as at least one first program code from an application database and programmed and, during the execution mode, the at least one first program code is executed.

### 2. Description of the Related Art

Programmable logic units (Field Programmable Gate Arrays (FPGAs)) allow the implementation of hardware-accelerated application logic. At present, however, applications must be tailored to a specific FPGA hardware platform.

Updating the hardware-accelerated application logic at runtime is impossible or can only be performed manually.

Application developers are also unable to develop a single application package that works on a number of platforms including platforms without an FPGA, such as in the cloud, where the missing hardware acceleration can be compensated for through the executing multiple application instances in parallel.

These restrictions no longer meet the increasing demands of IT/OT processes for fast and flexible provision of software components that are required due to the introduction of modern agile software provision processes, i.e., DevOps.

Most conventional FPGAs are configured at boot time of the hardware. This requires creating a boot image comprising a configuration bitstream for the FPGA and rebooting the hardware to load the new image.

Modern FPGAs support the dynamic partial reconfiguration of the programmable logic unit on the FPGA. Part of the programmable logic unit may thereby be reconfigured at runtime.

This function is used either at the development time, in order to reconfigure the FPGA partially with the aid of development tools, provided that the FPGA host or the device is connected directly to the development/debugging interface, such as USB, or during operation with the aid of complicated host programming interfaces.

For applications that have to be executed on different platforms, the established approach is to create two different application packages.

One package version supports general-purpose CPUs and another package version supports FPGA-accelerated logic for a specific hardware platform.

This process has various disadvantages. Creating two separate application packages requires different processes and development steps, which often comprise manual steps.

The packages are then provided separately on the respective target platforms depending on the hardware functions of each platform.

This increases development and maintenance outlay for these separate packages and leads to longer provision times due to the manual steps.

In order to support secure updating in the execution procedure, the application logic has to be updated at runtime of the device. While this can be achieved for software-based microservices, this is at present not performed fully automatically for microservices with hardware-accelerated application logic.

Multiple existing publications have focused on the concept of partial reconfiguration of FPGAs, which concept forms the basis of this invention.

In “A Cloud-Scale Acceleration Architecture”, Adrian M. Caulfield et al., 2016 49th Annual IEEE/ACM International Symposium on Microarchitecture (MICRO), the authors describe the use of reconfigurable logic to accelerate both functions on the network level and application logic with the aid of reconfigurable FPGAs, and to achieve direct FPGA-to-FPGA network communication.

The concept of partial reconfiguration of FPGAs is also an established technique that has been described in various publications, for example “Modular dynamic reconfiguration in Virtex FPGAs”, P. Sedcole, B. Blodget, T. Becker, J. Anderson, P. Lysaght, IEE Proceedings-Computers and Digital Techniques, Volume 153, Issue 3, “Incremental reconfiguration for pipelined applications”, H. Schmit, Proceedings, The 5th annual IEEE Symposium on Field-Programmable Custom Computing Machines Cat. No.97TB100186, or “Dynamic hardware plugins in an FPGA with partial run-time reconfiguration”, Edson L. Horta, John W. Lockwood, David E. Taylor, David Parlour, DAC '02: Proceedings of the 39th annual Design Automation Conference, June 2002, pgs. 343-348.

In “An Efficient Algorithm for Online Management of 2D Area of Partially Reconfigurable FPGAs”, Jun Cui, Qingxu Deng, Xiuqiang He, Zonghua Gu, IEEE 2007 Design, Automation & Test in Europe Conference & Exhibition, a description is given of an efficient algorithm for finding the complete set of maximum empty squares on a 2D FPGA partially reconfigurable at runtime.

In “A framework for secure remote updating of bitstream on runtime reconfigurable embedded platforms”, Tran Tranh, Pham Ngoc Nam, Tran Hoang Vu, Nguyen Van Cuong, IEEE 2012 Fourth International Conference on Communications and Electronics (ICCE), a description is given of a secure and efficient remote update of FPGA bitstream on embedded platforms reconfigurable at runtime in order to implement a solution only in hardware, i.e., for example, without operating system support.

Conventional platforms have one or more processors comprising one or more cores, and comprise a programmable logic unit that is fully or partially programmable and erasable.

An application program is usually developed on such platforms and is adapted to the platform, is compiled using drivers and is programmed once into the platform. However, this has the disadvantage of being inflexible, that changes can only be made with great difficulty and the application program cannot always be executed with optimum performance, because operating parameters of the platform, such as memory space, a highly variable number of incoming alarms, a network connection with load-dependent data transmission rate and/or the operating temperature of the platform during specific times of day, are not taken into consideration to a sufficient extent.

Publication WO 2013/192231 A1 discloses a system comprising a processor and an FPGA in which a process scheduler of the operating system of the common platform statically or dynamically assigns the execution of program codes either to the processor or to the FPGA.

Publication WO 2013/192236 A1 likewise discloses a system comprising a processor and an FPGA, in which a process scheduler of the operating system of the common platform statically or dynamically assigns the execution of program codes either to the processor or to the FPGA.

### SUMMARY OF THE INVENTION

It is an object of the invention to provide a method and a system in which it is made possible, during operation of a platform comprising a processor and a programmable logic unit for an application program, to reprogram the platform in a flexible manner, where the application program is intended to be provided from an application database connected to the platform.

This and other objects and advantages are achieved in accordance with the invention by a method in which, during the execution mode, the processor or the programmable logic unit checks, based on at least one predefined criterion, whether a second application program comprising at least one second module should be loaded from the application database, and if so, a change is made to the programming mode, and at least the at least one second module is loaded into the program memory and/or into the programmable logic unit so as to be executable as at least one second program code, and a change is then made to the execution mode, in which the at least one second program code is executed.

The term “so as to be executable” in the present context means that a program code of an application program is composed and compiled specifically for a target platform and, when stored in a program memory or in the programmable logic unit, can be executed directly on the target platform.

During compilation, program libraries, for example, for different drivers, such as an “FPGA region driver”, an “FPGA manager driver”, an “FPGA bridge driver” or a “vendor FPGA driver” may be taken into consideration.

The following aspects are taken into consideration here:

there is a driver on the operating system level that grants access to the programmable logic unit in the “programming mode”, and there is a driver on the operating system level that manages individual reconfigurable partitions of the programmable logic unit and synchronizes access thereto, which falls into the context of an FPGA region driver, and there is a driver that grants access to the loaded application logic in the “execution mode”.

Individual drivers may delegate parts, for example, of their functionality to an FPGA.

If the compiled program code is intended for storage and execution in the programmable logic unit, then “so as to be executable” also implies the storage or corresponding programming of the programmable logic unit.

During compilation of the application program, it is possible, for example, to generate multiple modules that are intended for execution by the processor or the programmable logic unit.

The processor may comprise multiple cores on which different modules are executed.

The programmable logic unit may be used to implement multiple mutually independent logic modules.

It is clear that, following a programming operation, it is necessary to change over from the programming mode to the execution mode. This may occur automatically, such as following successful programming of the logic unit.

If no explicit programming mode is provided, such as in the case of a processor, then the programming mode may also be considered to be the provision of a new program code in the program memory for execution by the processor.

Changing over or switching between the execution mode and the programming mode may be prompted or performed by the processor or the programmable logic unit. Here, at least one predefined criterion may be applied, for example, a resource usage level of the processor or of the programmable logic unit.

This makes it possible to achieve a situation whereby the application program can decide itself on the form, specifically either by the processor or by the programmable logic unit, in which the program code can be executed.

This results in a high degree of flexibility in terms of the program execution and very high efficiency during the execution itself.

The execution of the program code is less dependent on execution requirements of an operating system of the platform. Accordingly, the influence of a process scheduler of the operating system is able to be reduced, and in particular the dynamic execution performance of the platform can be increased as a whole.

Data or program codes may be provided into the program memory for example by the processor or else by DMA (“direct memory access”).

Hardware-accelerated application logic that can be provided flexibly on FPGAs may also be referred to as a “hardware microservice”.

On the other hand, there are “software microservices”, which are executed exclusively on general-purpose CPUs.

A hardware microservice comprises:
A bitstream or a bit string for the programmable logic unit (PL) of the FPGA comprising the compiled application logic.
An operating system driver in order to access application logic in the programmable logic unit from the user area.
A user space implementation that offers interfaces for hardware-accelerated application logic for use by other microservices.

Dynamic execution of one or more application programs by a platform is understood in the present context to mean that, during execution, a configuration change is made as to whether the application program or its program code or parts thereof, such as modules or “microservices”, is executed by the processor or the programmable logic unit.

Modules or “microservices” may be defined, for example, by a further, second application program that performs the same task as a first application program. Here, the executable program codes differ, but the first and second application program may be identical and differ only in terms of implementation, i.e., in terms of their modules or program codes.

A program code, a module or a microservice may be an implementation of an application program or of part thereof.

Many different implementations of an application program are possible, for example, for different platforms or for different configurations within the application program, such as variable distributions of logic and software modules, i.e., microservices.

The abovementioned bitstream of a microservice may likewise be an implementation of an application program.

The first program code may be an executable program code of a first application program optimized for a target platform and/or configured in accordance with a user specification or the current performance of platform.

The second program code may be an executable program code of the second application program optimized for a target platform and/or configured in accordance with a user specification or the current performance of the platform, where the second application program may correspond to the first application program.

The execution of an application program corresponds to the execution of the program code on the platform in the execution mode.

It is thereby possible to improve performance, but also to simplify licensing of software from libraries, because the software is optimized.

Licensing a hardware microservice may contain a complex implementation of a license check, which requires resources that in turn are not available to the platform for the execution of the application program. Provision may, however, also be made for no license to be necessary for the implementation of the same microservice in the form of software. The license may accordingly, for example, be a decision option for the implementation of the microservice.

The programming mode for a programmable logic unit may, for example, be a special operating mode in which logic gates of an FPGA are reconfigured. Simultaneous execution may be prevented.

The programming mode of a processor may, for example, correspond to the execution mode thereof, i.e., the program memory of the microprocessor may change during the execution of a program code.

In one embodiment of the invention, provision is made, during the check as to whether the second application program should be loaded, to determine and accordingly take into consideration the usage level of the processor, of the working memory of the processor, of the program memory, or of the programmable logic unit during the execution of the first application program.

This makes it possible to achieve a dynamic adaptation of the application program and thereby to achieve an optimum usage level of the resources of the platform or else optimum performance for the execution of the application program.

In one embodiment of the invention, provision is made, during the check as to whether the second application program should be loaded, to calculate, preferably estimate, and accordingly take into consideration a usage level of the processor, of the working memory of the processor, of the program memory, or of the programmable logic unit during the execution of the second application program. This makes it possible to achieve a dynamic adaptation of the application program to an estimated, future resource demand of the platform and thereby to achieve an optimum usage level of the resources of the platform or else optimum performance for the execution of the application program.

In one embodiment of the invention, the processor and/or the programmable logic unit is used to define whether the first and/or the second module should be stored in the program memory or in the programmable logic unit, preferably in the execution mode. This makes it possible to achieve a dynamic adaptation of the application program during the execution of the program code through the program code itself, and thus to achieve an optimum usage level of the resources of the platform or else optimum performance for the execution of the application program. The complexity of the platform may thereby be kept simple.

In one embodiment of the invention, an application management module, which is executed by a management system contained in the platform and which is incorporated into the connection between the application database and the processor and the programmable logic unit, defines whether the first and/or the at least one second module is stored in the program memory or in the programmable logic unit, preferably in the execution mode. This makes it possible to achieve a dynamic adaptation of the application program during execution of the program code through a corresponding management module, and thus to achieve an optimum usage level of the resources of the platform or else optimum performance for the execution of the application program.

The management module is part of a management system that is configured to manage and to configure the platform, to make status queries for the platform, or provides a connection to the application database.

Using the management module for the dynamic adaptation of the program code means that performance is not impaired during execution of the program code.

In another embodiment of the invention, the at least one second module loaded so as to be executable comprises a corresponding second processor program code for execution by the processor in the program memory, and a corresponding second logic program code for execution by the programmable logic unit in the programmable logic unit. This achieves a situation whereby both an executable program code for execution by the processor and an executable program code for execution by the programmable logic unit are available for the same module, and a dynamic changeover between these two program codes is made possible. This may advantageously be utilized in order, for example, to select and execute the desired program code depending on performance, without a corresponding programming operation being necessary immediately beforehand in the programming mode.

In a further embodiment of the invention, the predefined criterion comprises the exceedance of an operative limit value of the platform, the reaching of a predefined state for the first application program, triggering of an alarm or a fault notification on the platform, or the reaching of a predefined time. This may advantageously be utilized in order, for example, to perform a needs-oriented reconfiguration of modules of an application program. This makes it possible to implement a predefined, desired execution performance of the program code.

In one embodiment of the invention, at least two application programs, preferably at least three application programs and particularly preferably at least five or at least ten application programs are executed dynamically. This makes it possible to achieve a situation whereby a set of application programs with their respective program codes are executed optimally on the platform because it is possible to perform fine-tuning among the respective modules of the application programs.

In another embodiment of the invention, the first and the second application program are identical, but the at least one first and the at least one second program code are different. This makes it possible to achieve a situation whereby, for example, only the modules or program codes within an application program are reconfigured, recompiled and reprogrammed, and a runtime-dependent distribution of the modules between the processor and the programmable logic unit is thus achieved.

The objects and advantages in accordance with the invention are achieved by a system for dynamically executing at least one application program by a platform that includes a processor comprising a program memory and that includes a programmable logic unit, where the processor and the programmable logic unit support a programming mode and an execution mode, and where the system is configured to implement the method in accordance with the disclosed embodiments of the invention.

In one embodiment of the invention, the system to furthermore comprises an application management system comprising an execution memory and an application database that is configured to execute an application management module and to provide an application program to the platform. This achieves a situation whereby applications for programming the platform can be provided easily, in particular during operation of the platform.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in more detail below with reference to an exemplary embodiment illustrated in the accompanying drawings, in which:

FIG. 1 schematically shows a supply process for platform software in accordance with the invention;

FIG. 2 schematically shows a system for dynamically executing an application program in accordance with the invention; and

FIG. 3-5 show exemplary configurations for dynamically supplying the application program in accordance with the invention.

### DETAILED DESCRIPTION OF THE EXEMPLARY EMBODIMENTS

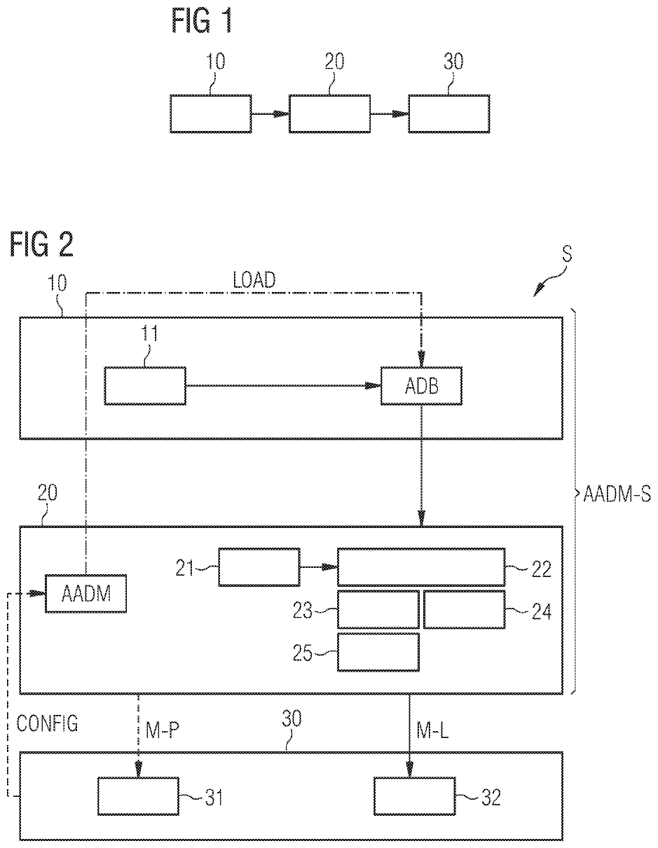

FIG. 1 schematically shows a supply process for platform software from an application program 10 via a “delivery pipeline” 20, i.e., the supply of the software from a database to the platform 30.

FIG. 2 shows a system S in accordance with the invention for dynamically executing an application program 11 of an application 10 by a platform 30.

The platform 30 has a processor comprising a program memory 31 and has a programmable logic unit 32, and is configured to execute the application program 10 in the form of at least one program code via the processor 31 and the programmable logic unit 32.

The system S furthermore comprises an application management system AADM-S comprising an execution memory and an application database ADB, such as an app store.

The application management system AADM-S is configured to execute an application management module AADM.

By way of example, the application management module AADM may make a configuration query CONFIG to the platform 30 to ascertain a current usage level brought about by the operation of an application program on the platform 30.

Should it be desired to change the current programming of the processor 31 or logic unit 32, then a corresponding query may be made by the application management module AADM to the application database ADB via a corresponding load request LOAD to modify the program code on the platform and to provide the application program 10, which corresponds to a desired configuration.

A configuration may be understood in the present context to mean a distribution of functional modules of an application program in the form of corresponding program codes M-P for execution by the processor 31 and/or of program codes M-L for execution by the programmable logic unit 32.

The application program is ascertained from the database ADB, and the modules of the application program 11 are composed and compiled or formed so as to create program codes, by way of what is known as a “delivery pipeline” 20, which is part of the application management system AADM-S.

The generation of the program code may, for example, include frameworks or other libraries 21, and FPGA region drivers 22, FPGA manager drivers 23, FPGA bridge drivers 24 or vendor FPGA drivers 25.

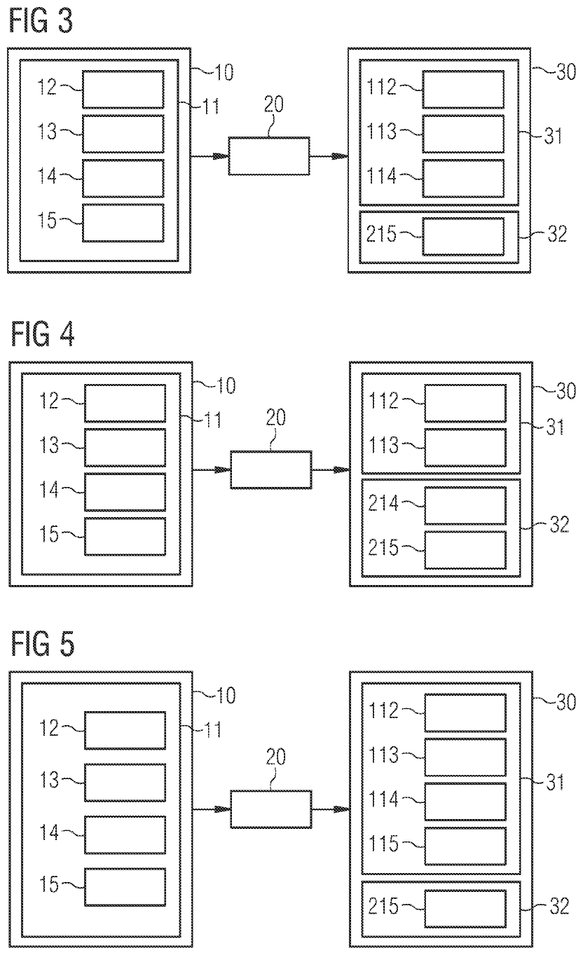

FIG. 3 to FIG. 5 schematically show the dynamic supply of an application 10 to a platform 30 via the “delivery pipeline” 20.

What is illustrated is an application program 11 comprising multiple software modules 12, 13, 14, 15, which cover, for example, different technical functionalities of the application program 11.

A request to reconfigure an application program 11 may then be generated, such as depending on the current performance of the application program that is executed by the platform.

FIG. 3 shows a first exemplary configuration in which the application program 11 is prepared in modules for execution by the processor 31, i.e., by incorporating the required libraries, drivers are compiled for execution by the processor and the interfaces thereof and program codes 112-114 are formed and stored in the program memory of the processor 31.

A module is, however, prepared for execution by the programmable logic unit 32, i.e., by incorporating the required libraries, drivers are compiled for execution by the logic unit and the interfaces thereof and a program code 215 is formed and the logic unit is programmed accordingly.

FIG. 4 shows a second exemplary configuration in which the application program 11 is prepared in modules for execution by the processor 31, i.e., by incorporating the required libraries, drivers are compiled for execution by the processor and the interfaces thereof and program codes 112-113 are formed and stored in the program memory of the processor 31.

A module is, however, prepared for execution by the programmable logic unit 32, i.e., by incorporating the required libraries, drivers are compiled for execution by the logic unit and the interfaces thereof and program codes 214-215 are formed and the logic unit is programmed accordingly.

FIG. 5 shows a third exemplary configuration in which the application program 11 is prepared in modules for execution by the processor 31, i.e., by incorporating the required libraries, drivers are compiled for execution by the processor and the interfaces thereof and program codes 112-115 are formed and stored in the program memory of the processor 31.

A module is, however, prepared for execution by the programmable logic unit 32, i.e., by incorporating the required libraries, drivers are compiled for execution by the logic unit and the interfaces thereof and a program code 215 is formed and the logic unit is programmed accordingly.

In this configuration, the program code 115 and also the program code 215 corresponds to the corresponding module of the application program 11. The same functionality for the module is consequently available both for execution by the processor 31 and for execution by the logic unit 32 and these are called dynamically in accordance with the respective situation.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-11. (canceled)

12. A computer-implemented method for dynamically executing at least one application program by a platform including a processor comprising a program memory including a programmable logic unit, the processor and programmable logic unit supporting a programming mode and an execution mode, during the programming mode, a first application program comprising at least one first module being loaded into at least one of the program memory and the programmable logic unit so as to be executable as at least one first program code from an application database and being programmed and, during the execution mode, the at least one first program code is executed, the method comprising:
checking during the execution mode, one of the processor or the programmable logic unit on which the at least one first program code is executed, based on at least one predefined criterion, whether a second application program comprising at least one second module should be loaded from the application database;
performing a change to the programming mode, and loading at least the at least one second module into at least one of the program memory and the programmable logic unit so as to be executable as at least one second program code, if the second application program comprising at least one second module should be loaded from the application database; and
implementing a change to the execution mode, in which the at least one second program code is executed, if the second application program comprising at least one second module should be loaded from the application database.

13. The method as claimed in claim 12, wherein a usage level of one of (i) the processor, (ii) the working memory and the program memory of the processor and (ii) the programmable logic unit are determined and accordingly taken into consideration during the execution of the first application program during the check to determine whether the second application program should be loaded.

14. The method as claimed in claim 12, wherein a usage level of one of (i) the processor, (ii) the working memory and program memory of the processor and (iii) the programmable logic unit is calculated, estimated and accordingly taken into consideration during the execution of the second application program during the check to determine whether the second application program should be loaded.

15. The method as claimed in claim 13, wherein at least one of the processor and the programmable logic unit is utilized to define whether at least one of the first and second module should be stored in one of the program memory and the programmable logic unit during the execution mode.

16. The method as claimed in claim 14, wherein at least one of the processor and the programmable logic unit is utilized to define whether at least one of the first and second module should be stored in one of the program memory and the programmable logic unit during the execution mode.

17. The method as claimed in claim 12, wherein an application management module, which is executed by a management system contained in the platform and which is incorporated into a connection between the application database and the processor and the programmable logic unit, defines whether at least one of (i) the first and (ii) the at least one second module is stored in one of the program memory and the programmable logic unit during the execution mode.

18. The method as claimed in claim 12, wherein the at least one second module loaded so as to be executable comprises a corresponding second processor program code for execution by the processor in the program memory, and a corresponding second logic program code for execution by the programmable logic unit in the programmable logic unit.

19. The method as claimed in claim 12, wherein the predefined criterion comprises one of an exceedance of an operative limit value of the platform, reaching a predefined state for the first application program, triggering an alarm or a fault notification on the platform and reaching a predefined time.

20. The method as claimed in claim 12, wherein at least two application programs are executed dynamically.

21. The method as claimed in claim 20, wherein at least three application programs.

22. The method as claimed in claim 21, wherein one of at least five and at least ten application programs are executed dynamically.

23. The method as claimed in claim 12, wherein the first and the second application program are identical; and wherein the at least one first and at least one second program code are different.

24. A system for dynamically executing at least one application program by a platform including a processor comprising a program memory and including a programmable logic unit, the processor and the programmable logic unit supporting a programming mode and an execution mode;
wherein the system is configured to:
load a first application program comprising at least one first module into at least one of the program memory and the programmable logic unit during the programming mode so as to be executable as at least one first program code from an application database to program the first application program and, during the execution mode, to execute the first application program;
wherein the system is configured to:
check during the execution mode, one of the processor or the programmable logic unit on which the at least one first program code is executed, based on at least one predefined criterion, whether a second application program comprising at least one second module should be loaded from the application database;
perform a change to the programming mode, and load at least the at least one second module into at least one of the program memory and the programmable logic unit so as to be executable as at least one second program code, if the second application program comprising at least one second module should be loaded from the application database; and
implement a change to the execution mode, in which the at least one second program code is executed, if the second application program comprising at least one second module should be loaded from the application database.

25. The system as claimed in claim 12, further comprising:
an application management system comprising an execution memory and an application database,
wherein the application management system is configured to execute an application management module and to provide an application program to the platform.
